(19) United States
(12) Patent Application Publication
(10) Pub. No.: US 2015/0042159 A1
(43) Pub. Date: Feb. 12, 2015

(54) CONVERTER APPARATUS AND METHOD OF ELECTRIC VEHICLE

(71) Applicant: Hyundai Motor Company, Seoul (KR)

(72) Inventors: Jongpil Kim, Yongin (KR); Seungwoo Ha, Suwon (KR); Sam Gyun Kim, Hwaseong (KR); Woo Young Lee, Chungcheongbuk-do (KR)

(73) Assignee: Hyundai Motor Company, Seoul (KR)

(21) Appl. No.: 14/144,239

(22) Filed: Dec. 30, 2013

(30) Foreign Application Priority Data
Aug. 12, 2013 (KR) 10-2013-0095373

(51) Int. Cl. B60L 11/18

(52) U.S. Cl. CPC B60L 11/1811
USPC 307/10.1

(57) ABSTRACT

An integrated converter and method are provided that combine an onboard charger and a low voltage direct current converter. The integrated improves the charging efficiency of the battery of a vehicle and supplies the high density power to an electronic device load. The charging efficiency of the high voltage battery and electricity transmitting efficiency to the low voltage converter is improved using the integrated converter. Furthermore, the low voltage converter receives high density power since the low voltage converter is input with a substantially stable voltage from the integrated converter.

### CROSS-REFERENCE TO RELATED APPLICATION

This application claims priority to and the benefit of Korean Patent Application No. 10-2013-0095373 filed in the Korean Intellectual Property Office on Aug. 12, 2013, the entire contents of which are incorporated herein by reference.

### BACKGROUND

(a) Field of the Invention

The present invention relates to a converter apparatus and method which charge a high voltage battery and a low voltage battery of an electric vehicle and supply necessary power for an electronic device load.

(b) Description of the Related Art

A plug-in hybrid electric vehicle (PHEV) or an electric vehicle (EV) charges a high voltage battery of the vehicle using a common alternating current (AC) power on board charger (OBC), and charges a low voltage battery of the vehicle using a low voltage direct current-direct current (DC-DC) converter (LDC) and supplies power for the electronic device load. The OBC generates a voltage (e.g., SoC minimum˜SoC maximum) that the battery requires based on a state of charge (SoC) of the battery. Then, the LDC supplies a variable high voltage input from the battery by converting to the input electronic device load and the low voltage battery.

In recent years, studies on improving the efficiency of the OBC which charges the high voltage battery of the electric vehicle and supplying the high density power to the LDC has been in progress.

The above information disclosed in this section is only for enhancement of understanding of the background of the invention and therefore it may contain information that does not form the prior art that is already known in this country to a person of ordinary skill in the art.

### SUMMARY

The present invention provides an integrated converter apparatus and method combining OBC and LDC which improves the charging efficiency of the battery of the electric vehicle, and supplies the high density power to an electronic device load.

According to an exemplary embodiment of the present invention, the integrated converter apparatus of the electric vehicle may include: a power converting module that converts an AC voltage input thereto into a first DC voltage and transmits the first DC voltage to a low voltage converter when the electric vehicle is charged; and a bidirectional buck-boost module that increases the first DC voltage to a second DC voltage and transmits the second DC voltage to a high voltage battery when the electric vehicle is charged, and reduces a third DC voltage output from the high voltage battery and transmits the reduced third DC voltage to the low voltage converter when the electric vehicle is operated.

The power converting module may include an AC power rectifying module that converts the AC voltage into the first DC voltage; a boosting module that increases the first DC voltage; and a rectifying module hat rectifies the increased first DC voltage. The boosting module may include at least one of a power factor correction boost (PFC boost) circuit, a continuous conduction mode (CCM) PFC circuit, and a semi-bridgeless interleaved PFC circuit. The rectifying module may include at least one of a phase shift full bridge circuit, a center tap synchronous rectifier circuit, a half bridge circuit, a series resonant converter circuit, a center tap diode rectifier circuit, and a full bridge diode rectifier circuit. The bidirectional buck-boost module may increase the first DC voltage to the second DC voltage and reduce the third DC voltage by operating a switch of the bidirectional buck-boost module. The low voltage converter may supply electric power to the low voltage battery of the electric vehicle and an electronic device load. The high voltage battery may supply the electric power to a motor/generator (MG) of the electric vehicle.

Additionally, the present invention provides a method of operating a converter of an electric vehicle. The method of operating a converter of an electric vehicle may include: converting an AC voltage input thereto into a first DC voltage and transmitting the first DC voltage to a low voltage converter when the electric vehicle is charged; increasing the first DC voltage to a second DC voltage and transmitting the second DC voltage to a high voltage battery when the electric vehicle is charged; and reducing a third DC voltage output from the high voltage battery and transmitting the reduced third DC voltage to the low voltage converter when the electric vehicle is operated.

The method may further include increasing the first DC voltage and rectifying the increased first DC voltage. In particular, the increasing of the first DC voltage may be implemented by at least one of a power factor correction boost (PFC boost) circuit, a continuous conduction mode (CCM) PFC circuit, and a semi-bridgeless interleaved PFC circuit. In addition, the rectifying the increased first DC voltage may be implemented by at least one of a phase shift full bridge circuit, a center tap diode rectifier circuit, a center tap synchronous rectifier circuit, a half bridge circuit, and a full bridge diode rectifier circuit.

Furthermore, the transmitting of the second DC voltage may include increasing the first DC voltage to the second DC voltage by operating a switch. The transmitting of the third DC voltage may include reducing the third DC voltage by operating a switch. In addition, the low voltage converter may supply electric power to a low voltage battery of the electric vehicle and an electronic device load. The high voltage battery may supply electric power to a motor/generator (MG) of the electric vehicle.

According to an exemplary embodiment of the present invention, the charging efficiency of the high voltage battery and power transmission efficiency to the low voltage converter may improve using the integrated converter apparatus. In other words, a conduction loss of a first element of the DC/DC voltage transformation module of the integrated converter apparatus may be reduced and a diode forward voltage reduction included in the rectifying module may be reduced, thereby reducing a power loss. In addition, the power loss in an output protection diode may be reduced since the integrated converter apparatus does not use the output protection diode. Furthermore, the low voltage converter may receive high density power since the low voltage converter may be input with a stable voltage from the integrated converter apparatus. Further, volume of the low voltage converter may be reduced since the low voltage converter may be implemented by a low-capacity element, thus improving the efficiency of the low voltage converter.

### BRIEF DESCRIPTION OF THE DRAWINGS

FIG. 1 is an exemplary block diagram of a charging system of an electric vehicle according to an exemplary embodiment of the present invention;

FIGS. 2A and 2B are exemplary diagrams illustrating a circuit of a charging system of an electric vehicle according to an exemplary embodiment of the present invention; and

FIG. 3 to FIG. 7 are exemplary diagrams illustrating a circuit of a charging system of an electric vehicle according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, only certain exemplary embodiments of the present invention have been shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, each of the terms “unit”, “-er”, “-or”, “module”, and “block” described in the specification refers to a unit that processes at least one function or operation, which may be implemented by hardware, software, or a combination of thereof.

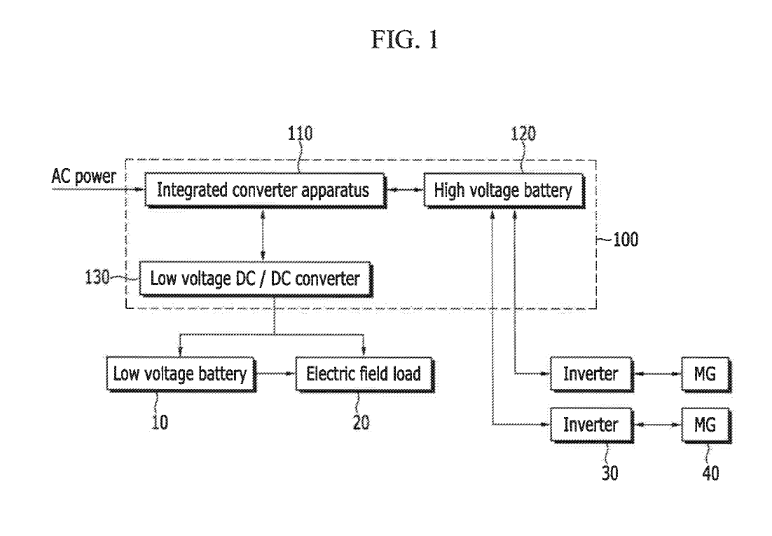

FIG. 1 is an exemplary block diagram of an integrated converter of an electric vehicle according to an exemplary embodiment of the present invention. Referring to FIG. 1, a charging system 100 of the electric vehicle according to an exemplary embodiment of the present invention may include an integrated converter 110, a high voltage battery 120, and a low voltage DC/DC converter 130.

The integrated converter 110 may be configured to convert AC input power into DC power, charge the high voltage battery 120, and supply the power to the low voltage DC/DC converter 130. The high voltage battery 120 may be configured to supply the power to a plurality of inverters 30 using the power charged through the integrated converter 110, to operate a motor/generator (MG) or supply the power to the low voltage DC/DC converter 130. The low voltage DC/DC converter 130 may be configured to receive the power from the integrated converter 110 or high voltage battery 120, to charge a low voltage battery 10 or supply the power to an electronic device load 20.

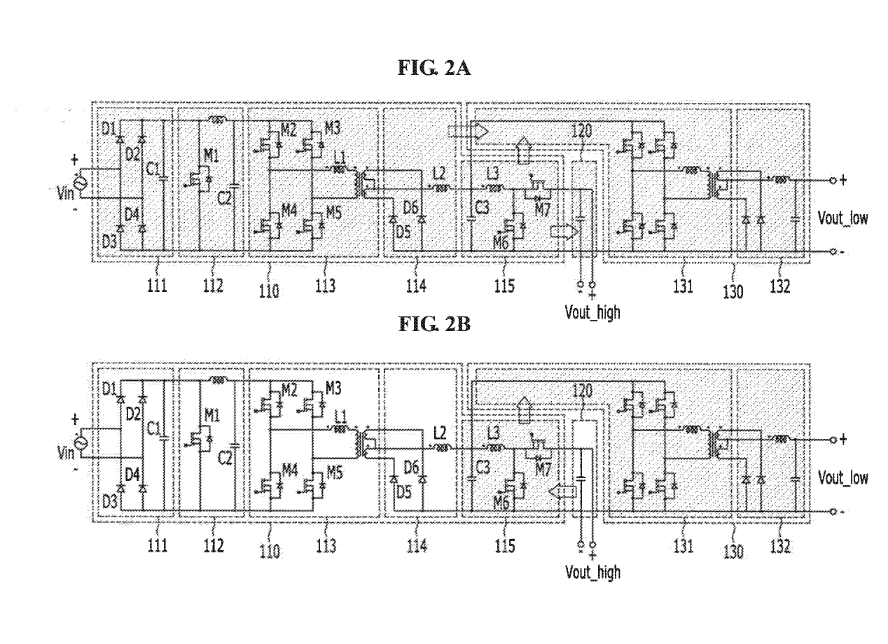

FIG. 2 is an exemplary diagram illustrating an integrated converter circuit of the electric vehicle according to an exemplary embodiment of the present invention. Referring to FIG. 2, a charging system 100, executed by a controller, according to an exemplary embodiment of the present invention may include the integrated converter 110, the high voltage battery 120, and the low voltage DC/DC converter 130. The integrated converter 110 may include an AC power rectifying module 111, a power factor correction boost module 112, a DC/DC voltage transformation module 113, a rectifying module 114, and a bidirectional buck-boost module 115.

According to an exemplary embodiment of the present invention, the power factor correction boost module 112 of the integrated converter as illustrated FIG. 2 may be implemented by a power factor correction boost (PFC boost) converter, the DC/DC voltage transformation module 113 may be implemented by a phase shifted full bridge converter, and the rectifying module 114 may be implemented by a center tap diode rectifier.

FIG. 2A is an exemplary diagram illustrating the charging system when the electric vehicle is charging according to an exemplary embodiment of the present invention. A rectifier diode (D1 to D4) of the AC power rectifying module 111 may be configured to generate a full-wave rectification waveform from a waveform of an AC voltage (Vᵢₙ), and a capacitor C1 may be configured to transmit a DC voltage to the power factor correction boost module 112 by discharging a charged voltage at a falling curve of the full-wave rectification waveform.

The power factor correction boost module 112 may be configured to correct a power factor (pf) using a power factor correction inductor L1 and a power factor correction capacitor C2, and increase a DC voltage by operating a switch M1. The power factor correction boost module 112 of the integrated converter 110 according to an exemplary embodiment of the present invention may be configured to reduce the size of the integrated converter by designing the correction capacitor C2 to be smaller in size. Since the low voltage DC/DC converter 130 may receive energy from a capacitor of the bidirectional buck-boost module 115, the reduced capacitor C2 may be used.

Further, the increased DC voltage may be output as a minimum SoC of the battery through the DC/DC voltage transformation module 113 and the rectifying module 114. In other words, the DC voltage may be transmitted from the rectifying module 114 to the low voltage DC/DC converter 130. The DC/DC voltage transformation module 113 may be configured to transform a size of the DC voltage by adjusting a duty cycle ratio with a switch (M2 to M5). In addition, the rectifying module may be configured to transform an output voltage from a secondary coil of the DC/DC voltage transformation module to the DC voltage using rectifier diodes (D1 and D2).

The bidirectional buck-boost module 115 may be configured to increase the DC voltage output from the rectifying module 114, and charge the high voltage battery 120 to a necessary voltage (e.g., a predetermined voltage). A voltage of the capacitor C3 may be formed consistently regardless of a voltage condition of the battery. A consistent voltage formed on the capacitor C3 may become a SoC minimum voltage or maximum voltage. The bidirectional buck-boost module 115 may be configured to perform a role of a boost converter to generate a necessary voltage of the high voltage battery during the high voltage battery 120 charging. The bidirectional buck-boost module 115 may be configured to generate an output voltage based on the duty ratio of a switch M6 as shown in Equation 1 below, wherein D6 is the ratio of duty of switch M6 to duty of switch M7.

$${V}_{out \_ high} = \frac{{V}_{C 3}}{1 - D 6} \qquad Equation 1$$

The high voltage battery 120 may be configured to transmit a voltage (Vₒᵤₜ_{_{—}}_{high}) to operate a motor generator 40 to an inverter 30 connected to the motor generator 40 when the electric vehicle is operated. The inverter 30 may be configured to convert the DC voltage of the high voltage battery 120 into an AC voltage, and transmit the AC voltage to the motor generator 40. According to an exemplary embodiment of the present invention, the bidirectional buck-boost module 115 may be configured to transmit a voltage of the capacitor C3 based on the duty ratio of a switch M7 to the low voltage DC/DC converter 130 when the electric vehicle is operated. The bidirectional buck-boost module 115 may be configured to operate as a reduction converter when the electric vehicle is operated, to allow the bidirectional buck-boost module 115 to maintain (e.g., fix) a voltage V_{C3} despite receiving the voltage from the high voltage battery. In addition, the bidirectional buck-boost module 115 may be configured to generate a necessary voltage of the low voltage battery by reducing a voltage V_{C31} after maintaining the voltage V_{C31} as a maximum voltage, and may maintain a voltage of the low voltage DC/DC converter as a SoC maximum voltage by increasing a voltage of the low voltage battery when the electric vehicle is operated. In other words, the voltage V_{C3} may be maintained as a minimum or maximum SoC voltage using the bidirectional buck-boost module 115 when the electric vehicle is charged or operated.

Furthermore, according to an exemplary embodiment of the present invention, the bidirectional buck-boost module 115 may be configured to increase the DC voltage by changing a switching duty ratio of switches (M6 and M7), and an output voltage from the bidirectional buck-boost module 115 may include in the range of a minimum SoC voltage to a maximum SoC voltage. In other words, the DC/DC voltage transformation module 113 may be designed regardless of a charging voltage of the high voltage battery 120 since the bidirectional buck-boost module 115 may be configured to transmit a necessary voltage of the high voltage battery 120.

The DC/DC voltage transformation module 113 may be configured to generate a voltage regardless of a voltage condition of the high voltage battery 120 and reduce current flow through a first switch element of the DC/DC voltage transformation module 113. A low voltage may be transmitted to the rectifying module 114 according to these features, to reduce a voltage stress of the rectifying module 114 and to allow the integrated converter 110 to use a rectifying switch which has a reduced conduction loss. In addition, the bidirectional buck-boost module 115 may be configured to charge the high voltage battery 120 normally by changing the boost duty ratio even though the AC power input to the integrated converter 110 may be instantaneously shut off. Furthermore, the integrated converter 110 may not use a traditional output protection diode connected to an output terminal of on board charger. Therefore, a power loss in the output protection diode may be minimized.

Meanwhile, a voltage transmitted to the low voltage DC/DC converter 130 may be a minimum or maximum SoC voltage output from the DC/DC voltage transformation module 113 and the rectifying module 114. A low voltage DC/DC voltage transformation module 131 of the low voltage DC/DC converter 130 may adapt a minimum or maximum SoC voltage to a low voltage (Vₒᵤₜ_{_{—}}_{low}) to be supplied from the low voltage DC/DC converter 130 by adjusting the duty ratio. The output voltage from a traditional low voltage DC/DC converter 130 may be flexible since the traditional low voltage DC/DC converter 130 receives a voltage from the high voltage battery 120. However, the low voltage DC/DC converter 130 according to an exemplary embodiment of the present invention may be configured to receive a stable voltage from the rectifying module 114 of the integrated converter 110 regardless of a voltage of the high voltage battery.

The integrated converter 110 that receives the AC power when the electric vehicle is charged may be configured to charge the high voltage battery 120 and supply the power to the low voltage DC/DC converter 130 according to an exemplary embodiment of the present invention. In other words, the integrated converter 110 may use a minimum or maximum SoC voltage output from the rectifying module 114 while supplying the power to the low voltage DC/DC converter 130, and may use a particular size of the minimum or maximum SoC voltage increased or reduced using the bidirectional buck-boost module 115 during charging the high voltage battery 120.

FIGS. 2A and 2B are exemplary diagrams illustrating a charging system when the electric vehicle is operated according to an exemplary embodiment of the present invention. A charged power in the high voltage battery 120 may be supplied to the low voltage DC/DC converter 130 since the AC power may not input from the exterior when the electric vehicle is operated. Furthermore, the high voltage battery 120 may be charged by receiving electricity generated in the motor generator 40 when the electric vehicle is operated.

In particular, a voltage output from the high voltage battery 120 may be transmitted to the low voltage DC/DC converter 130 through a switch M7. A voltage output from the high voltage battery 120 may be a fixed voltage depending on a duty ratio of an inductor L3 and the switch M7 included in the bidirectional buck-boost module 115. Further, the low voltage DC/DC voltage transformation module 131 of the low voltage DC/DC converter 130 may be configured to adapt a minimum or maximum SoC voltage to a voltage supplied by the low voltage DC/DC converter 130 based on adjustment of the duty ratio, and output the voltage Vₒᵤₜ_{_{—}}_{low} by rectifying in a rectifying module 132.

A voltage input to the low voltage DC/DC converter 130 may be substantially constant regardless of the electric vehicle being charged or operated. The output voltage from the traditional low voltage DC/DC converter 130 may also be flexible since the traditional low voltage DC/DC converter 130 receives a voltage from the high voltage battery 120. However, the low voltage DC/DC converter 130 may be configured to receive a substantially stable voltage from the bidirectional buck-boost module 115 of the integrated converter 110.

The high voltage battery 120 according to an exemplary embodiment of the present invention may become a power source of the low voltage DC/DC converter 130 while the electric vehicle is operated. In other words, the efficiency of the low voltage DC/DC converter 130 may be improved since a constant voltage transmitted by the bidirectional buck-boost module 115 output from the high voltage battery 120 may be supplied to the low voltage DC/DC converter 130. In addition, a rectifying switch which has a minimal conduction loss may be used on account of reducing a voltage stress of the rectifying module of the low voltage DC/DC converter 130 based on the input voltage changing.

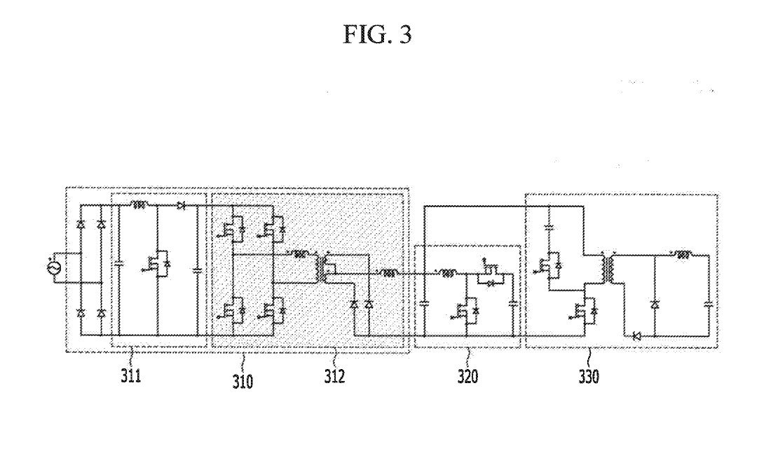

FIG. 3 is an exemplary diagram illustrating a circuit of an integrated converter of the electric vehicle according to another exemplary embodiment of the present invention. A power factor correction boost module 311 as illustrated in FIG. 3 may be implemented by a continuous conduction mode (CCM) PFC, and a DC/DC voltage transformation module 312 may be implemented by a phase-shifted full-bridge DC/DC converter. Moreover, the integrated converter 310 as illustrated in FIG. 3 may include a bidirectional buck-boost module 320 and a low voltage DC/DC converter 330 implemented by an active forward converter.

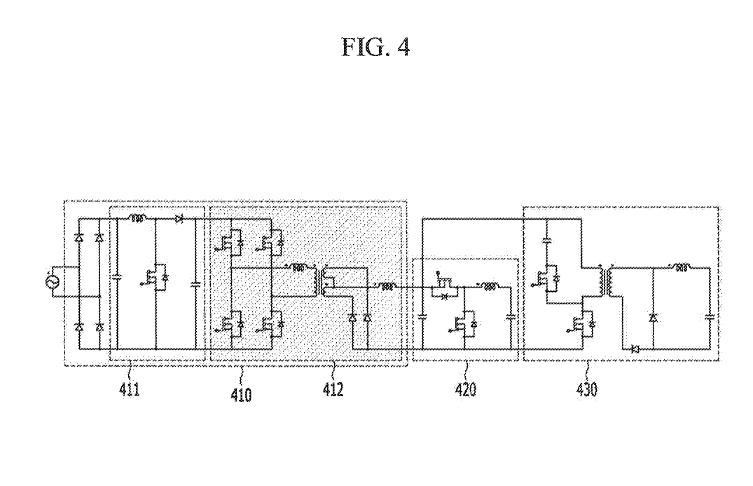

FIG. 4 is an exemplary diagram illustrating a circuit of an integrated converter of the electric vehicle according to another exemplary embodiment of the present invention. A power factor correction boost module 411 as illustrated in FIG. 4 may be implemented by a CCM PFC, and a DC/DC voltage transformation module 412 may be implemented by a phase-shifted full-bridge DC/DC converter. Moreover, the integrated converter apparatus 410 as illustrated in FIG. 4 may include a bidirectional buck-boost module 420 and a low voltage DC/DC converter 430 implemented by an active forward converter.

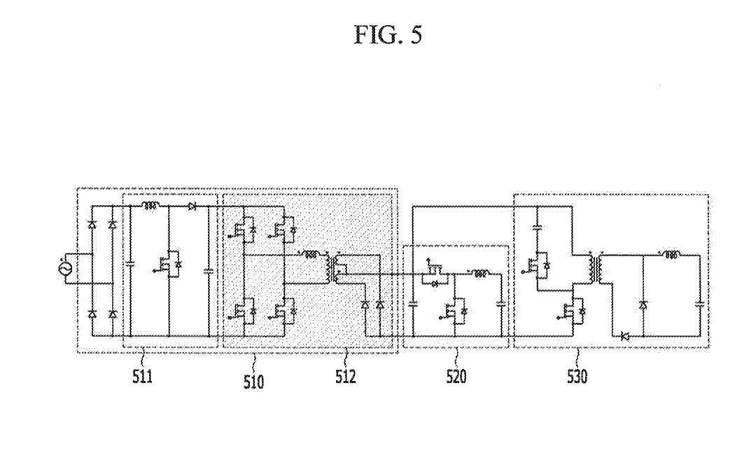

FIG. 5 is an exemplary diagram illustrating a circuit of the integrated converter of the electric vehicle according to another exemplary embodiment of the present invention. A power factor correction boost module 511 as illustrated in FIG. 5 may be implemented by a CCM PFC, and a DC/DC voltage transformation and rectifying module 512 may be implemented by a resonant full bridge DC/DC converter and a center tap diode rectifier. Moreover, the integrated converter 510 as illustrated in FIG. 5 may include a bidirectional buck-boost module 520 and a low voltage DC/DC converter 530 implemented by a synchronous active forward converter.

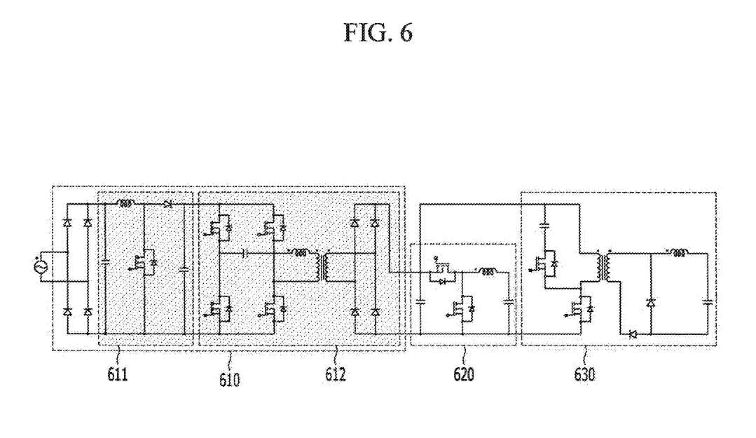

FIG. 6 is an exemplary diagram illustrating a circuit of the integrated converter of the electric vehicle according to another exemplary embodiment of the present invention. A power factor correction boost module 611 as illustrated in FIG. 6 may be implemented by a CCM PFC, and a DC/DC voltage transformation and rectifying module 612 may be implemented by a resonant full bridge DC/DC converter and a full bridge diode rectifier. Moreover, the integrated converter 610 as illustrated in FIG. 6 may include a bidirectional buck-boost module 620 and a low voltage DC/DC converter 630 implemented by a synchronous active forward converter.

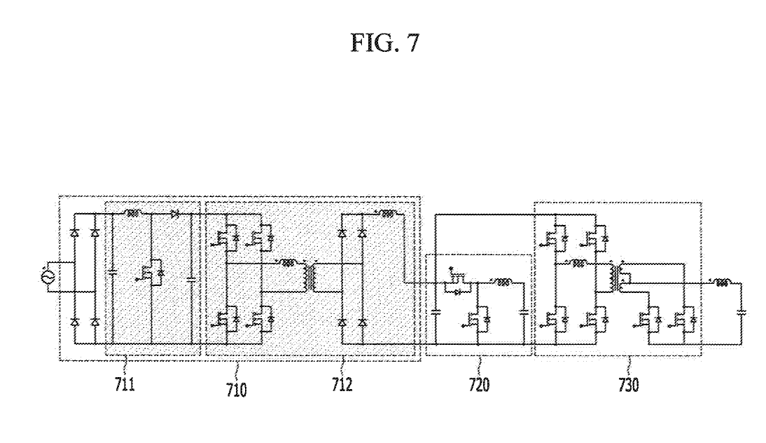

FIG. 7 is an exemplary diagram illustrating a circuit of the electric vehicle's charging system according to another exemplary embodiment of the present invention. A power factor correction boost module 711 as illustrated in FIG. 7 may be implemented by a CCM PFC, and a DC/DC voltage transformation and rectifying module 712 may be implemented by a phase-shifted full-bridge DC/DC converter and a full bridge diode rectifier. Moreover, the integrated converter 710 as illustrated in FIG. 7 may include a bidirectional buck-boost module 720 and a low voltage DC/DC converter 730 implemented by a full bridge sensor tap synchronous rectifier.

As described above, according to an exemplary embodiment of the present invention, charging efficiency of the high voltage battery and power transmission efficiency to the low voltage converter may be improved using the integrated converter. In other words, a conduction loss of a first transformer switch of the DC/DC voltage transformation and rectifying module of the integrated converter may be reduced to extend switching capability. Therefore, a diode forward voltage drop included in the rectifying module may be reduced, thus reducing a power loss. In addition, the power loss in an output protection diode may be reduced since the integrated converter may not use the output protection diode. Furthermore, the low voltage converter may receive high density power since the low voltage converter may input a substantially stable voltage from the integrated converter. In addition, volume of the low voltage converter may be reduced since the low voltage converter may be implemented by a low-capacity element, improving the efficiency of the low voltage converter can be improved.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

What is claimed is:

1. A converter apparatus of a vehicle comprising:
a power converting module configured to convert an input alternating current (AC) voltage into a first direct current (DC) voltage and transmit the first DC voltage to a low voltage converter when the vehicle is charged; and
a bidirectional buck-boost module configured to increase the first DC voltage to a second DC voltage and transmit the second DC voltage to a high voltage battery when the vehicle is charged, and reduce a third DC voltage output from the high voltage battery and transmit the reduced third DC voltage to the low voltage converter when the vehicle is operated.

2. The converter apparatus of the electric vehicle of claim 1, wherein the power converting module includes:
an AC power rectifying module configured to convert the AC voltage into the first DC voltage;
a boosting module configured to increase the first DC voltage; and
a rectifying module configured to rectify the increased first DC voltage.

3. The converter apparatus of the vehicle of claim 2, wherein the boosting module includes at least one of a group consisting of: a power factor correction boost (PFC boost) circuit, a continuous conduction mode (CCM) PFC circuit, and a semi-bridgeless interleaved PFC circuit.

4. The converter apparatus of the vehicle of claim 2, wherein the rectifying module includes at least one of a group consisting of: a phase shift full bridge circuit, a center tap synchronous rectifier circuit, a half bridge circuit, a series resonant converter circuit, a center tap diode rectifier circuit, and a full bridge diode rectifier circuit.

5. The converter apparatus of the vehicle of claim 1, wherein the bidirectional buck-boost module is configured to increase the first DC voltage to the second DC voltage and reduce the third DC voltage by operating a switch of the bidirectional buck-boost module.

6. The converter apparatus of the vehicle of claim 1, wherein the low voltage converter is configured to supply electric power to the low voltage battery of the vehicle and an electronic device load.

7. The converter apparatus of the vehicle of claim 1, wherein the high voltage battery is configured to supply the electric power to a motor/generator (MG) of the vehicle.

8. A method of operating a converter of a vehicle, comprising:
converting, a controller, an input alternating current (AC) voltage into a first DC voltage and transmitting the first direct current (DC) voltage to a low voltage converter when the vehicle is charged;
increasing, by the controller, the first DC voltage to a second DC voltage and transmitting the second DC voltage to a high voltage battery when the vehicle is charged; and
reducing, by the controller, a third DC voltage output from the high voltage battery and transmitting the reduced third DC voltage to the low voltage converter when the vehicle is operated.

9. The method of claim 8, further comprising:
increasing, by the controller, the first DC voltage and rectifying the increased first DC voltage.

10. The method of claim 9, wherein increasing is implemented by at least one of a group consisting of: a power factor correction boost (PFC boost) circuit, a continuous conduction mode (CCM) PFC circuit, and a semi-bridgeless interleaved PFC circuit.

11. The method of claim 9, wherein rectifying is implemented by at least one of a group consisting of: a phase shift full bridge circuit, a center tap diode rectifier circuit, a center tap synchronous rectifier circuit, a half bridge circuit, and a full bridge diode rectifier circuit.

12. The method of claim 8, wherein transmitting the second DC voltage includes:
increasing, by the controller, the first DC voltage to the second DC voltage by operating a switch.

13. The method of claim 8, wherein transmitting the third DC voltage includes:
reducing, by the controller, the third DC voltage by operating a switch.

14. The method of claim 8, wherein the low voltage converter is configured to supply electric power to a low voltage battery of the vehicle and an electronic device load.

15. The method of claim 8, wherein the high voltage battery is configured to supply electric power to a motor/generator (MG) of the vehicle.
